(19) United States
(12) Patent Application Publication
(10) Pub. No.: US 2013/0176555 A1
(43) Pub. Date: Jul. 11, 2013

(54) DEVICE AND METHOD FOR DETECTING FLAWS IN CONTINUOUSLY PRODUCED FLOAT GLASS

(71) Applicants: Wolfgang Zorn, Munchen (DE); Peter Krug, Munchen (DE); Winfried Baller, Kirchseeon (DE); Florian Bader, Peissenberg (DE)

(72) Inventors: Wolfgang Zorn, Munchen (DE); Peter Krug, Munchen (DE); Winfried Baller, Kirchseeon (DE); Florian Bader, Peissenberg (DE)

(73) Assignee: Grenzebach Maschinenbau GmbH, Asbach-Baumenheim (DE)

(21) Appl. No.: 13/825,649

(22) PCT Filed: Sep. 21, 2011
(86) PCT No.: PCT/DE11/01772

§ 371 Date: Mar. 22, 2013

(30) Foreign Application Priority Data
Sep. 24, 2010 (DE) 10 2010 046 433.3

(51) Int. Cl. G01N 21/896

(52) U.S. Cl. CPC G01N 21/896
USPC 356/72; 356/239.1

(57) ABSTRACT

The invention relates to a method and device for detecting flaws in a continuously produced float glass band by checking a glass strip, which extends perpendicularly to the conveying direction and which is observed in transmitted light. The device has the following characteristics: a) the flow of a float glass band is monitored without any gaps by a modularly constructed fastening bridge, scanning sensors fastened to the fastening bridge and two transmission lighting means arranged perpendicular to the glass band, b) each scanning sensor can be oriented by an adjusting apparatus according to the three spatial coordinates in positive and negative directions and can be finely adjusted by a target apparatus that can be pivoted in, in the form of an artificial measurement plane, and c) the lighting means are cooled by a cooling apparatus.

### CROSS-REFERENCE TO RELATED APPLICATIONS

This application is a National Stage application of International Application No. PCT/DE2011/001772, filed on Sep. 21, 2011, which claims priority of German application Serial Number 10 2010 046 433.3, filed on Sep. 24, 2010, both of which are incorporated herein by reference in their entireties.

### BACKGROUND OF THE INVENTION

1. Field of the Invention

The invention relates to a device and a method for detecting flaws in continuously produced float glass.

2. Description of the Prior Art

DE 196 43 017 C1 discloses a method for determining optical defects, in particular of the refractive power, in large-area panes of a transparent material such as glass, in which, by projecting a defined pattern onto the glass and imaging this pattern onto a camera, the image observed is evaluated. This is done by a light-dark sequence of the grid pattern being respectively imaged onto a number of adjacently arranged pixels of the camera and the number being an integer multiple of the light-dark sequence. The object of this invention is to specify a method with which optical defects in at least one dimension of a pane can be determined locally without any reference pattern. Flaws in a continuously proceeding fabrication process of float glass cannot be determined hereby.

A method and a device for determining the optical quality and for detecting defects of flat glass, in particular of float glass, or other optically transparent materials are described in DE 198 13 072 A1. In this case, a video camera substantially observes a lighting device through the glass, wherein the focus is located on the glass and the video camera generates signals on the basis of the quality of the glass and said signals are evaluated. Such a known method is intended to achieve the object of devising a method in which no dead zones are present and the intensity of deflection (refractive power) and the magnitude of the glass defect can be determined. In addition, a measurement of the nucleus of the defect in the glass is to be possible. This object is to be achieved in that use is made of a lighting device the color and/or intensity of which change in a defined manner from one outer edge to the other, further in that, in the fault-free state of the glass, the observation spot of the video camera is located approximately in the center of the lighting device, in that the lighting device is assigned two video signals u₁, u₂ depending on color and/or intensity, and in that a change in the intensity of the video signal u₁, u₂ is used to assess the quality of the glass.

Flaws in a continuously proceeding fabrication process of float glass can likewise not be determined by this method.

### SUMMARY OF THE PRESENT INVENTION

The device according to the invention and, respectively, the corresponding method are therefore based on the object of proposing a device and a method with which, during the running process of the production of a band of liquid glass, what is known as float glass, the formation of flaws, for example in the form of inclusions, bubbles or similar undesired phenomena, can be detected and monitored continuously.

This object is achieved by a device for detecting flaws in a continuously produced float glass band by checking a glass strip which extends perpendicularly to the conveying direction and is observed in transmitted light, having the following features:
a) a modularly constructed fastening bridge for scanning sensors which is designed in accordance with the width of the float glass band to be checked, wherein the scanning sensors cover said width without any gaps with regard to their coverage area and the float glass band is illuminated in transmission without gaps by a linear lighting means with constant luminous flux and an adjacent linear lighting means with oscillating luminous flux,
b) an adjusting apparatus which is assigned to each scanning sensor and which permits a change in the position of each scanning sensor in the positive and negative direction along the 3 spatial coordinates,
c) a target apparatus which is assigned to each scanning sensor and can be pivoted in the form of an artificial measuring plane for the accurate alignment of a scanning sensor on the surface of the float glass band,
d) a cooling apparatus for cooling the lighting means, and by a method for detecting flaws in a continuously produced float glass band by checking a glass strip which extends perpendicularly to the conveying direction and is observed in transmitted light, having the following features:
   a) by a modularly constructed fastening bridge (3) and scanning sensors fastened thereto, and two transmission lighting means arranged perpendicularly to the glass band, the flow of a float glass band is monitored without any gaps,
   b) each scanning sensor can be aligned in the positive and negative direction in accordance with the 3 spatial coordinates by an adjusting apparatus and adjusted precisely by a target apparatus (16) which can be pivoted in the form of an artificial measuring plane,
   c) the lighting means are cooled by a cooling apparatus.

The device according to the invention will be described in more detail below.

### BRIEF DESCRIPTION OF THE DRAWINGS

In detail:

FIG. 1 shows a perspective plan view of a device according to the invention,

FIG. 2 shows a front view of the device according to FIG. 1,

FIG. 3 shows a view from above of the device according to FIG. 1,

FIG. 4 shows a side view of the device according to FIG. 1,

FIG. 5 shows a perspective illustration of the lighting means,

FIG. 6 shows a functional sketch of the adjustment of a scanning sensor.

### DETAILED DESCRIPTION OF THE PRESENT INVENTION

The basic idea of the present invention is, firstly, by what are known as scanning sensors, for example in the form of line cameras, to monitor the flow of the float glass band continuously and, secondly, also to create the possibility of being able to re-adjust or replace the individual scanning sensors, in the event of a repair or partial failure, during this continuous monitoring operation.

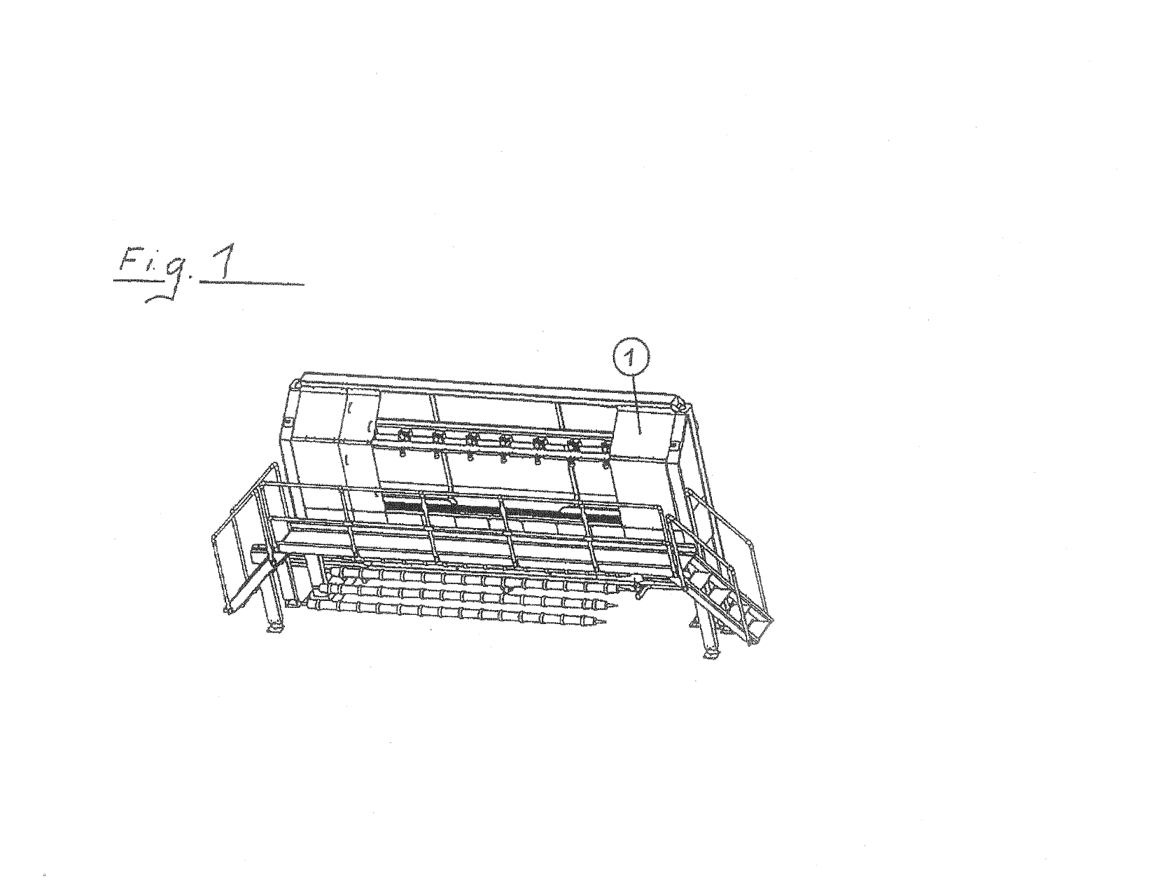

FIG. 1 shows a perspective plan view of a device according to the invention. The representation from a bird's-eye view makes it possible to see the bridge-like overall concept which spans the glass band progressively flowing away from the melt furnace. Said glass band is not shown here, but only the running rollers which convey the glass band onward are sketched. On the left-hand and the right-hand side of the observation and maintenance bridge shown, in each case staircases lead to an observation and maintenance catwalk. Here, only part of the overall protective cladding is designated by 1.

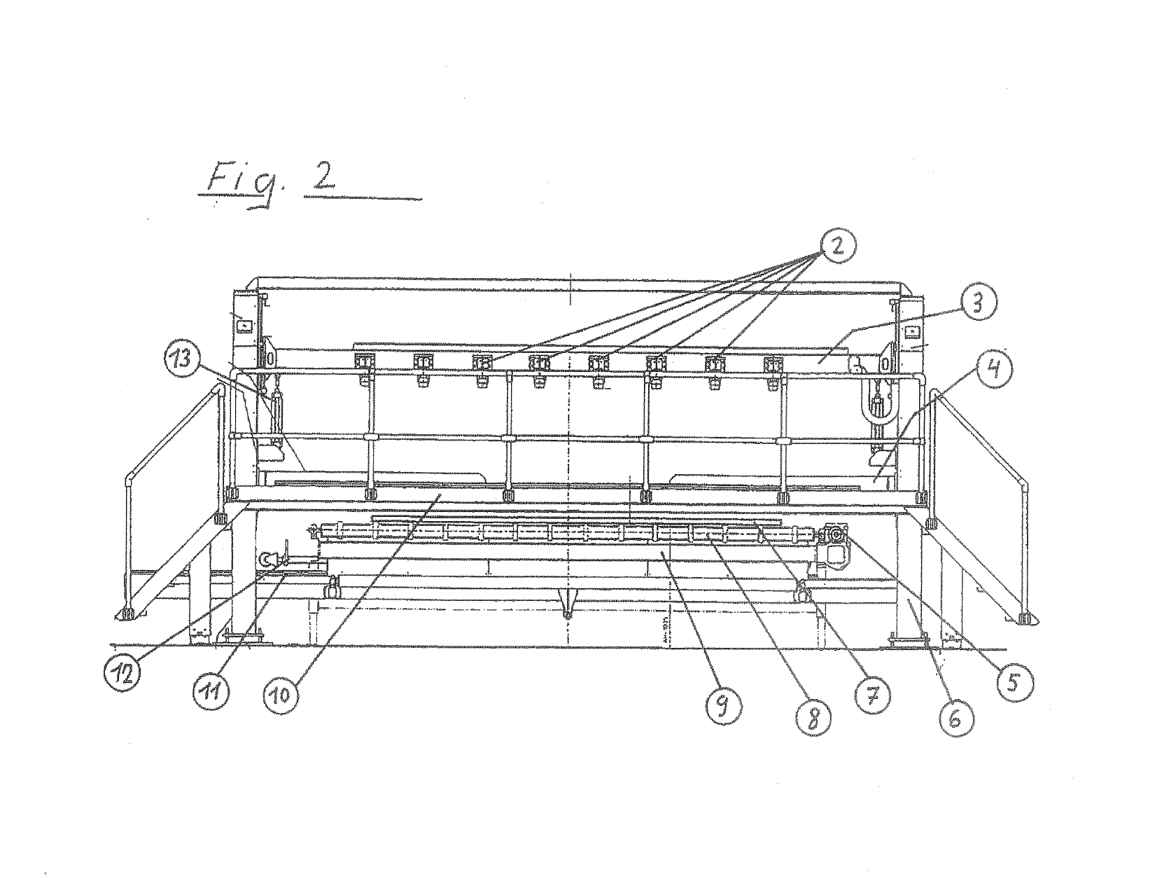

FIG. 2 shows a front view of the device according to FIG. 1. In addition to the staircases known from FIG. 1, the maintenance bridge 10, which is supported on the base frame 6, can be seen in section here. A strip of flat glass 7 is sketched here on a conveying roller 8, which is mounted on a cross-member 9 and is driven by a drive 5. As the upper termination of the base frame 6, above the railings of the maintenance bridge 10, the fastening bridge 3 for the scanning sensors 2 can be seen in section. Here, 11 represents the running rail for a lighting apparatus 17, and 12 the positional support for this lighting apparatus. On the left-hand side of the overall device, a lifting apparatus 13 of the fastening bridge 3 for the scanning sensors 2 is shown. A corresponding lifting apparatus 13 is located on the right-hand side of the fastening bridge 3.

By using this lifting apparatus 13, it is possible to raise the entire fastening bridge 3 for the repair of one or more scanning sensors 2 and/or the associated adjusting apparatus 14 and, by the respective target apparatus 16 that can be pivoted in, to adjust the respective scanning sensor 2 without the reference surface of an otherwise necessary flat glass 7. Although this necessitates a brief interruption to the detection of flaws, the procedure of adjusting a scanning sensor by the target apparatus 16 that can be pivoted in can be shortened so highly as compared with the prior art that continued running of the glass band can be economic. This is because, from an economic point of view, the temporary failure of the possibility of detecting flaws, as compared with the previously necessary complicated breaking off and melting of the glass band, may appear to be tolerable.

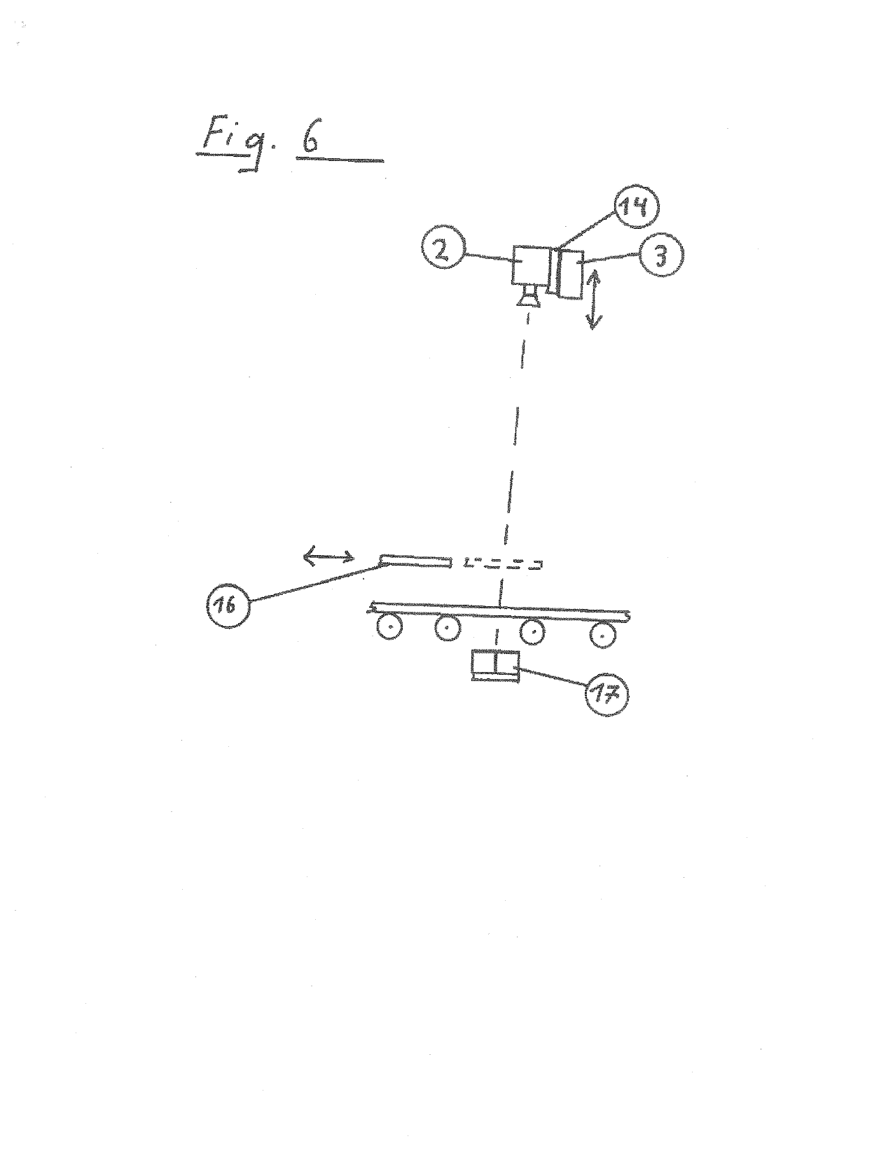

An additional lighting apparatus 4 is illustrated in section on the right-hand side of the maintenance bridge 10, analogous to a corresponding apparatus 4 on the left-hand side. This apparatus spans the entire width of the strip of flat glass, but its central part is not visible in this illustration. The function of this apparatus will be described later during the explanation of FIG. 6.

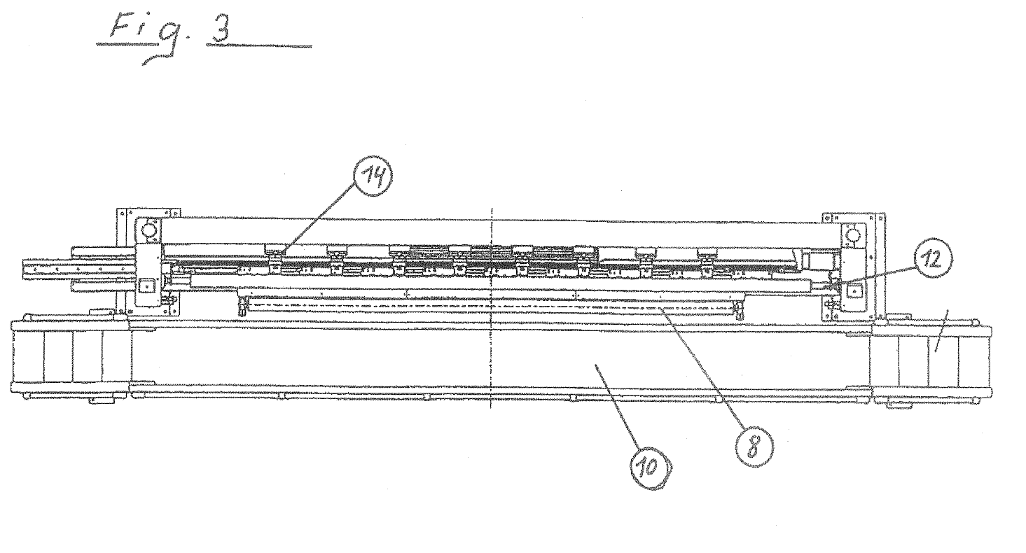

In FIG. 3, a view from above of the device according to FIG. 1 is shown. In addition to the known maintenance bridge 10 and a conveying roller 8 already described, here the physical assignment of the support 12 for the lighting apparatus 17 can be seen better. From this position, the adjusting apparatuses 14 (eight are drawn in here) for the scanning sensors 2 can easily be seen.

These adjusting apparatuses 14 can not only be raised and lowered overall with the scanning sensors 2 by the lifting apparatus 13, but in addition each intrinsically has the possibility of being moved independently of one another in all 3 spatial coordinates.

Thus, it is firstly necessary that the scanning sensors 2 can move in the direction of the longitudinal extent of the fastening bridge 3, here designated as the X direction, for example, both in the positive and also in the negative X direction, in order to ensure gap-free combination of the images of all the scanning sensors 2 involved over the entire width of the glass strip to be checked. This means that, in this way, it is possible to ensure by control that an image of a scanning sensor 2 ends where the image of the adjacent scanning sensor 2 starts.

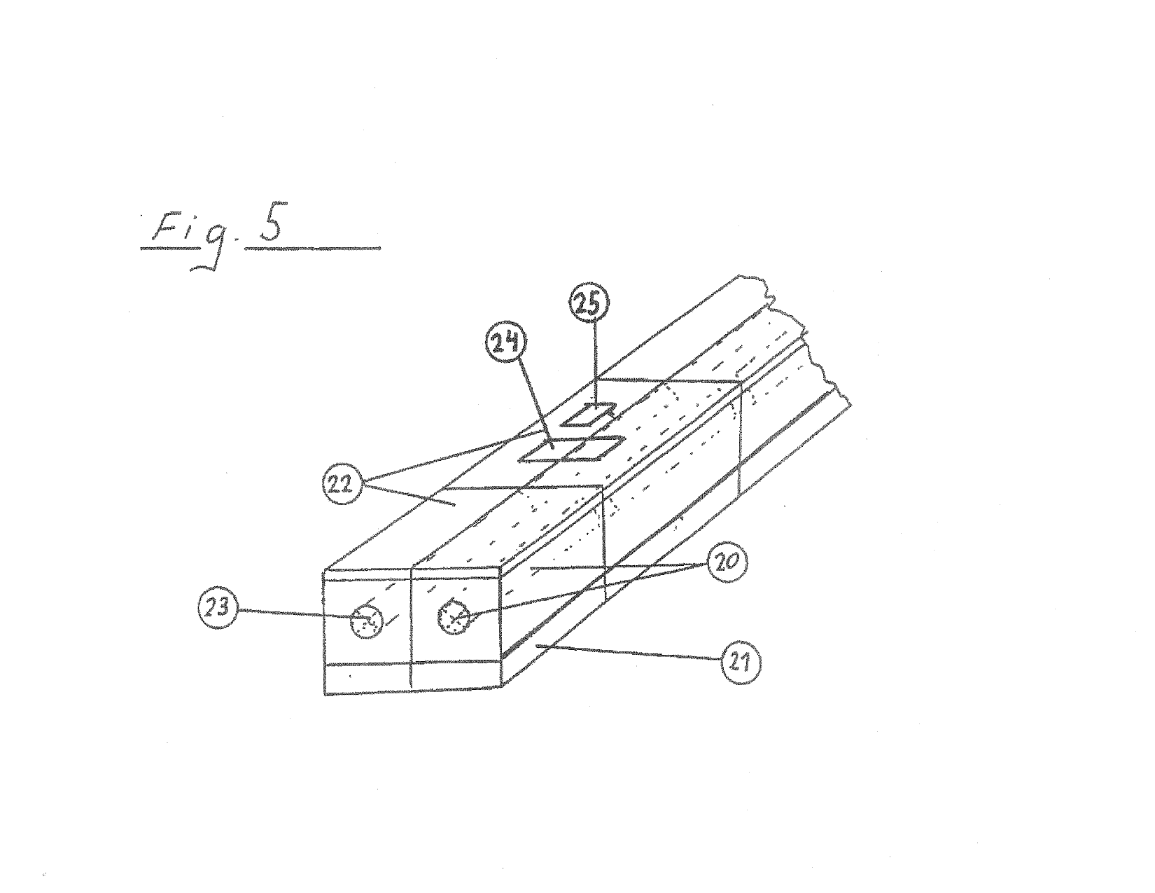

Furthermore, for the correct alignment of each individual scanning sensor 2, it is necessary that the center thereof is aligned accurately on the dividing line between the linear lighting means 20 (oscillating) and the lighting means 23 (constant lighting) (FIG. 5). For this purpose, a possible movement both in the positive and in the negative Y direction is necessary, the Y direction forming a horizontal plane with the X direction and including a right angle with the X direction.

Furthermore, in addition a possible displacement of an individual scanning sensor 2 in the vertical direction, that is to say the Z axis, is necessary for the case in which an individual scanning sensor 2 must be adjusted precisely by the target apparatus 16 described later.

As a particular refinement, provision is made that, in the case of the re-adjustment of an individual scanning sensor 2 during the running operation of the float glass production, a gap-free testing operation is maintained in that each scanning sensor 2 with its associated adjusting apparatus 14 has an associated second version of itself at the closest possible distance in the direction of the glass flow. This second version is used for the purpose of replacing the corresponding first version in functional terms during the adjustment or the complete replacement thereof For this purpose, depending on the physical conditions, it may be necessary in a particular refinement to provide the additional possibility of a slight tilting inclination in the second version, in order to cover the same region on the dividing line between the two lighting means 20 and 23. This is necessitated by the horizontal offset of the respective first version and of the second version of a scanning sensor 2 and the associated adjusting apparatus 14 of the latter.

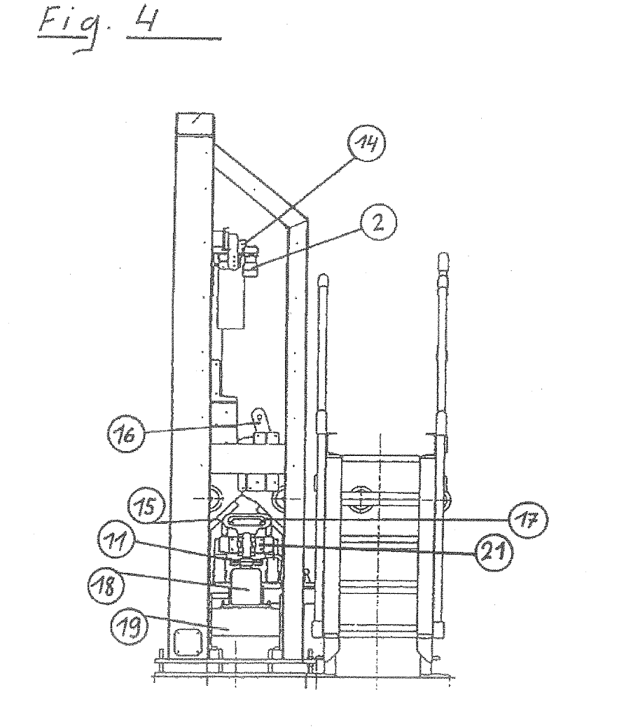

FIG. 4 shows a side view of the device according to FIG. 1. Beginning from above, here a scanning sensor 2 with its associated adjusting apparatus 14 is illustrated in section. 16 designates a target apparatus 16 that can be pivoted in, the function of which will be explained in more detail in the description of FIG. 6. Further below, the lighting apparatus 17 with the associated protective panels 15, of which only the left-hand one is designated, can be seen. The cross-member 19 which is connected to the base frame 6 carries the main beam 18 of the lighting apparatus. Above the latter, the running rail 11, which can be seen in the longitudinal view in FIG. 2, is illustrated in cross section. The running rail 11 is used for the purpose of permitting the withdrawal of the lighting apparatus 17 during operation for repair purposes and, after repairs have been carried out, of ensuring rapid insertion. A cooling apparatus 21 ensures the cooling of the lighting apparatus 17 and thus the maintenance of the correct operating temperature of the lighting apparatus 17, the lighting means 20, 23 of the latter.

In FIG. 5, a perspective illustration of the lighting means 20, 23 is shown in enlarged form. The lighting means are expediently assembled in a modular fashion with regard to their longitudinal extent in accordance with the width of the glass band to be illuminated. Together, to a certain extent, they form 2 light strips running in parallel, of which one has linearly arranged lighting means 20 oscillating in their light intensity, and the other has linearly arranged lighting means 23 constant in their light intensity. The frequency of the oscillating light intensity here is preferably equal to the line frequency of the line camera and, respectively, the frequency of the activation of a scanning sensor 2. It is further preferred for these frequencies to be an integer multiple of each other.

In the case of a flaw-free glass, the center of observation of each scanning sensor, for example a video camera, lies in the region of the boundary line of the lighting means 20 and the lighting means 23. In the event of a glass defect occurring, this observation center is displaced out of this central position as a result of refraction of light. As a result, at the location of the detected glass defect, different influences result on the output signal in the region of the relevant scanning sensor 2. From the change of two successive signals from a scanning sensor 2 and the additional information about the defect location and/or the position in the region of the relevant scanning sensor 2, in a novel way a resultant error signal can be obtained from the comparison of the measured values of two optical channels related to each other and can be fed to a circuit arrangement for fault detection and for further signal processing.

For more detailed explanation, in FIG. 5 the two portions of the area A1 and A2 are drawn. Here, the larger area A1, overlapping the dividing line of the two lighting means 20 and 23, is assigned to both lighting means, while the area A2 is assigned only to the region of the lighting means 23 having the constant light intensity. In the region of a pixel by pixel measurement of these optical channels, the two areas A1 and A2 deliver different measured values which, in the region of specific threshold values, permit safe conclusions about the type and the extent of a measured flaw.

The cooling apparatus 21 acts on the underside of the two light strips. A cover 22, which acts simultaneously as a light diffuser, forms the termination of the light strips opposite the underside of the glass band to be checked. As a special refinement of the device according to the invention, a second version of the above-described lighting means 20 and 23 can be provided, which, in terms of the position (parallel to the first version), correspond to the above-described second version of the adjusting apparatus 14 and the respective associated scanning sensor 2. In the event of a repair or the entire replacement of a lighting means unit or parts thereof, this additional arrangement ensures the undisturbed operation of the entire device according to the invention by an automatic changeover operation to this second version. The aforementioned additional tilting device on each adjusting apparatus 14 for the respective scanning sensor 2 is not necessary in this case, since the second version of an adjusting apparatus 14 is arranged directly above the center line of the second version of the lighting means 20 or 23. The respective second version, be it now the adjusting apparatus 14 or the lighting means 20 or 23, is arranged upstream of the first version in order to detect approaching flaws in advance and to supply them to further evaluation. It goes without saying that these second versions must likewise have corresponding, additional target devices 16 that can be pivoted in.

FIG. 6 shows a functional sketch of the adjustment of a scanning sensor. Above the lighting apparatus 17 described above, the glass band to be checked runs on the rollers sketched. If the new adjustment or the re-adjustment of a scanning sensor 2 becomes necessary, by the adjusting apparatus 14, the appropriate scanning sensor 2 is raised a little and at the same time a target apparatus 16 is pivoted into the beam path of the lighting apparatus 17.

This target apparatus 16 has fixed marks in the form of simple lines and/or crossed lines of specific thickness and/or color, by which the respective sensor 2 can automatically be aligned in a desired reference position in accordance with a defined program.

Here, the appropriate scanning sensor 2 is raised to an extent which corresponds to the distance of the target apparatus 16 from the glass band. The adjusting apparatus 14 subsequently adjusts the relevant scanning sensor 2 in accordance with the optical predefinitions of the horizontal alignment of the target apparatus. After the adjustment of the scanning sensor has been carried out, the target apparatus 16 pivots back again and the scanning sensor is lowered again to its predetermined working height above the glass plate 7.

The additional lighting apparatus 4 has additional lighting means such as, for example, LEDs, UV lamps, quartz lamps, xenon lamps or helium lamps, which offer additional possibilities for determining undesired glass properties. These depend on the type of glass and the specific requirements on the glass mixture produced and thus the glass parameters or glass defects to be detected in each case.

In a particular refinement, an additional apparatus for measuring the glass thickness, for example by laser or ultrasound, assigned in position to each scanning sensor 2, can also be provided. With such an apparatus, the thickness of the glass band produced can additionally be detected and recorded during the production process, resolved in the transverse direction and longitudinal direction. These measured values can be used to monitor the production process of the float glass band.

In a particular refinement of the invention, provision can additionally be made that, at the same time as the detection of flaws in the float glass, a device for measuring and monitoring stresses in the glass band is provided. To this end, a method is proposed in which polarized light is sent into the glass band, wherein stresses that occur effect birefringence, and the emergent light beam is analyzed in order to determine the changes caused by the birefringence and thus the stresses occurring. These stresses are determined by sweeping continuously over the width of the glass band, registering the aforesaid changes of the birefringence type and simultaneously measuring the temperature at the relevant point swept over in each case. From the measured changes in the birefringence and the associated measured temperature at the respective measuring point, the permanent stress at the relevant measuring point and, as a whole, thus the entire width of the glass band can be determined. The continuous measurements of these stress variations in the width of the glass band supply important pointers to stresses in the float glass band in the longitudinal direction, which represent a high potential hazard to the entire fabrication.

The region subjected to the polarized light ray radiated in preferably has a diameter of less than 20 mm in this case. The temperature measurement can be carried out, for example, with an optical pyrometer. The control of the complex movement processes and the signal processing of the sensors used requires a specific control program.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

We claim:

1. A device for detecting flaws in a continuously produced float glass band by checking a glass strip which extends perpendicularly to the conveying direction and is observed in transmitted light, wherein said device comprises the following features:
a) a modularly constructed fastening bridge for scanning sensors which is designed in accordance with the width of the float glass band to be checked, wherein the scanning sensors cover said width without any gaps with regard to their coverage area and the float glass band is illuminated in transmission without gaps by a linear lighting means with constant luminous flux and an adjacent linear lighting means with oscillating luminous flux,
b) an adjusting apparatus which is assigned to each scanning sensor and which permits a change in the position of each scanning sensor in the positive and negative direction along the 3 spatial coordinates,
c) a target apparatus which is assigned to each scanning sensor and can be pivoted in in the form of an artificial measuring plane for the accurate alignment of a scanning sensor on the surface of the float glass band, and
d) a cooling apparatus for cooling the lighting means.

2. The device as claimed in claim 1, wherein the determination of flaws by the scanning sensors is carried out by comparing the pixel measured values from two optical channels, wherein one channel relates to a portion of area A1 which the lighting means and cover, while the other channel relates to an associated portion of area A2 which only the lighting means covers, and the comparison and the evaluation of these measured values is carried out while taking specific threshold values into account.

3. The device as claimed in claim 1, wherein while taking account of a short piece of unchecked glass band, said device further comprises a lifting apparatus for raising the entire fastening bridge for repair purposes and lowered again.

4. The device as claimed in claim 1, wherein the adjusting apparatuses and the associated scanning sensors and/or the lighting means upstream of the float glass band are each assigned an identical second version which, in the event of failure of the first version, can replace the latter.

5. The device as claimed in claim 1, further comprising an additional lighting apparatus which contains specific lighting means for determining further glass parameters or glass defects.

6. The device as claimed in claim 1, wherein each scanning sensor is physically assigned an additional apparatus for measuring the glass thickness in the coverage area thereof.

7. The device as claimed in claim 1, wherein, by a further, simultaneously operated, device, monitoring of the stresses in the glass band is carried out by a sliding, local feed of polarized light sweeping over the width of the glass band and a simultaneous temperature measurement at the respective measuring point of the glass band.

8. A method for detecting flaws in a continuously
produced float glass band by checking a glass strip which extends
perpendicularly to the conveying direction and is observed in transmitted
light, said method comprising the steps of
a) monitoring the flow of a float glass band without any gaps a modularly constructed fastening bridge and scanning sensors fastened thereto, and two transmission lighting means arranged perpendicularly to the glass band,
b) aligning each scanning sensor in the positive and negative direction in accordance with the 3 spatial coordinates by an adjusting apparatus and precisely adjusting by a target apparatus which can be pivoted in in the form of an artificial measuring plane, and
c) cooling the lighting means by a cooling apparatus.

9. The method as claimed in claim 8, wherein the determination of flaws by the scanning sensors is carried out by comparing the pixel measured values from two optical channels, wherein one channel relates to a portion of area A1 which the lighting means and cover, while the other channel relates to an associated portion of area A2 which only the lighting means covers, and the comparison and the evaluation of these measured values is carried out while taking specific threshold values into account.

10. The method as claimed in claim 8, further comprising the step of, while taking account of a short piece of unchecked glass band, raising the entire fastening bridge by a lifting apparatus for repair purposes and lowering again.

11. The method as claimed in claim 8, wherein the adjusting apparatuses and/or the lighting means upstream of the float glass band are each assigned an identical second version which, in the event of failure of the first version, can replace the latter.

12. The method as claimed in claim 8, further comprising the step of providing an additional lighting apparatus which contains specific lighting means for determining further glass parameters.

13. The method as claimed in claim 8, wherein each scanning sensor is physically assigned an additional apparatus for measuring the glass thickness in the coverage area thereof.

14. The method as claimed in claim 8, further comprising the step of a further, simultaneously operated, device, monitoring the stresses in the glass band by a sliding, local feed of polarized light sweeping over the width of the glass band and a simultaneous temperature measurement at the respective measuring point of the glass band.

15. A computer program having a program code for carrying out the method steps as claimed in claim 8 when the program is executed in a computer.

16. A machine-readable carrier having the program code of a computer program for carrying out the method as claimed in claim 8 when the program is executed in a computer.
